(19) United States
(12) Patent Application Publication
(10) Pub. No.: US 2006/0079167 A1
(43) Pub. Date: Apr. 13, 2006

(54) Ventilation component for window panes, especially window panes of a motor vehicle

(75) Inventors: Fritz Krause, Hargatz (DE); Bernd Westerhoff, Langenargen (DE)

Correspondence Address: Stephen B. Salai, Esq.;Harter, Secrest & Emery LLP, 1600 Bausch & Lomb Place, Rochester, NY, 14604-2711, US

(73) Assignee: Metzeler Automotive Profile Systems GmBh, Lindau/Bodensee (DE)

(21) Appl. No.: 10/527,228

(22) PCT Filed: Sep. 11, 2003
(86) PCT No.: PCT/EP03/10133

§ 371 Date: Jun. 10, 2005

(30) Foreign Application Priority Data
Sep. 13, 2002 (DE) 102 42 641.4

(51) Int. Cl. B60S 1/54

(52) U.S. Cl. 454/121

(57) ABSTRACT

The invention relates to an air vent module for window panes (13), in particular window panes of a motor vehicle (10). Said module comprises a tubular-shaped flow channel (20). The flow channel (20) extends along a window pane (13) and is provided with at least one outlet (21), which is arranged opposite the window pane (13). Said outlet (21) extends in a vertical manner (z) approximately parallel to the window pane (13) and is defined by an upper edge (22) and a lower edge (23). The flow channel (20) is arranged in a shaft (14), which receives the window pane (13) and comprises a low sealing lip (30), which is adjacent to the window pane (13). Said lower sealing lip (30) is arranged in the region of the lower edge (23) such that the air flow exiting from the outlet (21) flows against the window pane (13).

### FIELD OF THE INVENTION

The invention relates to an air vent module for window panes, in particular automotive window panes, comprising a tubular duct extending along a window pane and provided with at least one vent opposite the window pane. The vent extends in an upright direction roughly parallel to the window pane and is defined by an upper edge and a lower edge. The duct is disposed in a door cavity accommodating the window pane and is provided with a lower sealing lip in contact with the window pane.

### BACKGROUND ART

Such an air vent module serves primarily to prevent the window panes from becoming fogged or iced. For this purpose, air heated by a heater is directed through the duct. The air flows through the vent of the duct and impinges the window pane, to thus prevent the window pane from becoming fogged or iced as caused by the condensation of water vapor, ensuring a clear view through the window pane.

As an alternative, cooled air can be directed through the duct, for instance for creating a comfortable air condition in the vehicle interior for the occupants. Temperature and flow of the air flowing through the duct can be regulated, for example, by an automatic air-conditioner.

An air vent module in the aforementioned sense is understood to be an assembly of several components, forming a functional unit for ready replacement within a system as a whole.

An air vent module finding application in a motor vehicle reads from EP 0 992 410 A1. This known air vent module is formed by a seal for weathersealing an automotive window pane. The seal comprises two sealing lips spaced away from each other and contacting the window pane. A cavity formed by the sealing lips and the window pane serves as the duct into which heated air is introduced. In an alternative aspect of this known air vent module tubing including outlets forming the actual duct can be disposed between the sealing lips.

The disadvantage with this known air vent module is the relatively small flow cross-section of the duct as a result of it being disposed between the sealing lips, resulting in an inadequate flow volume or noisy flow due to the relatively high flow velocity required. A further drawback with this known air vent module is that the window pane is fanned by the air flowing from the duct over a relatively small area. Defogging or deicing the window pane thus fails to be achieved to a satisfactory degree.

Known further from DE 198 12 489 C1 is a device for ventilating automotive side windows comprising an air guide channel configured in a separate channel component. This channel component is arranged in a side component of a vehicle door and provided with air outlets in an area facing a side window, the air outlets porting into a gap between the vehicle door and the side window. The air guide channel and the air outlets are combined into a single component that can be assembled complete as a unit. This known ventilation device is thus an air vent module in the aforementioned sense.

The channel component of the ventilation device is provided with a sealing profile in contact with the side window. The function of the sealing profile consists of sealing and stabilizing the powered side window 2. The sealing profile can be formed by an existing outer wall of the channel component made of rubber, for example. Although this known ventilation device is characterized in this way by the integration of the air supply and sealing functions, the drawback here is that the air flow is jetted from the air outlets uncontrolled into the gap between vehicle door and side window, resulting in flow losses.

The invention is based on the objective of sophisticating an air vent module of the aforementioned kind so that a relatively large flow cross-section of the duct and a relatively expansive air fanning of a window pane is now achievable.

To achieve this objective an air vent module having the characteristics as cited above is provided in accordance with the invention as it reads from claim 1 such that the lower sealing lip for jetting the window pane by an air flow emerging from the vent is arranged in the region of the lower edge.

The air vent module in accordance with the invention is the result of having discovered that sufficient room exists in the interior of the door cavity accommodating the window pane so that a duct is now achievable with a relatively large flow cross-section. In this arrangement, the duct may be configured as a separate component or integrated, for instance, in the inner trim of the automotive door. In addition, the air vent module in accordance with the invention now assures a relatively expansive air fanning of the window pane. This is due particularly to the lower sealing lip now being arranged in the region of the lower edge of the vent in ensuring a directed jetting of the window pane by the flow of air emerging from the vent. The sealing lip is expediently disposed so that the air flow impinges the window pane substantially tangentially in achieving effective fanning. Further contributing towards a favorable jetting of the window pane is that the vent extends vertically roughly parallel to the window pane. It is in this way that the air flow is jetted from the vent substantially perpendicular to the main direction of flow in the duct resulting in a turbulent and thus particularly effective flow along the window pane.

The air vent module in accordance with the invention is associated with the further advantage that slotted outlets of an inner trim, as they are often found in the prior art, are dispensable, resulting in the visual appeal of the inner trim no longer being spoiled.

Advantageous aspects of the air vent module in accordance with the invention read from the subject matter of claims 2 to 13.

In regard to directed jetting of the window pane it is further of advantage when the lower edge is level with a bottom surface of the duct in thus enabling the air flowing through the duct to be jetted from the vent unobstructed. It has additionally been discovered to be particularly of advantage when the upper edge is located in the upright direction below the top surface of the duct. A sidewall of the duct remaining above the vent in this arrangement contributes, for one thing, towards a large flow cross-section of the duct, whilst, for another, ensuring that the air flow jetted from the vent impinges the lower sealing lip in thus being definedly directed at the window pane.

In one preferred aspect of the air vent module in accordance with the invention an upper sealing lip is secured to the duct in contact with the window pane and spaced away upright from the lower sealing lip, the upper sealing lip being preferably arranged in the region of the upper edge. The upper sealing lip assists jetting the window pane in preventing flow losses.

Preferably, the upper sealing lip is provided with ports to permit emergence of the air flow from the vent through the upper sealing lip in fanning out over the window pane above the upper sealing lip. Furthermore, the ports prevent air backing up between the lower sealing lip and the upper sealing lip in thus assuring unobstructed circulation of the air flow.

In another preferred aspect of the air vent module in accordance with the invention the lower sealing lip and/or the upper sealing lip are positively connected to the duct to ensure facilitated assembly and cost-effective fabrication. For this purpose the lower sealing lip and/or the upper sealing lip is preferably provided with an appendage, which locates in a recessed groove of the duct. As an alternative the lower sealing lip and/or the upper sealing lip can be materially positively connected to the duct, preferred by coextrusion.

For ensuring adequate compliance it has further proven to be of advantage to make the lower sealing lip and/or the upper sealing lip of a thermoplastic elastomer (TPE) or ethylene propylene diene monomer (EPDM). To ensure high resistance to wear and tear, the upper side of the lower sealing lip and/or the underside of the upper sealing lip is coated to enhance in addition the heat resistance of the sealing lips in regard to a heated air flow jetted from the vent.

To facilitate fitting the duct in the door cavity housing the powered window pane, it has proven to be of advantage when the duct comprises a flange for securing to an inner wall of the door cavity, preferably to a carrier. The flange is preferably downswept approximately orthogonally from the duct. It is especially when the air vent module finds application in a side door of a motor vehicle having a carrier for collision protection that the flange in this way permits optimum location of the duct above or below the carrier.

For directed jetting of the window pane, preferably a plurality of vents is provided each separated from the other by a ridge.

To take into account the lightweight design mandatory particularly in automotive engineering, the duct in a preferred aspect of the air vent module in accordance with the invention is made of plastics, preferably of a thermoplastic elastomer. It is in this way that the duct can be configured relatively lightweight with adequate rigidity. In addition, making the duct of a thermoplastic elastomer facilitates variable design of the duct in flexibly conforming to the space available in the door cavity.

### BRIEF DESCRIPTION OF THE DRAWINGS

Details and further advantages of the air vent module in accordance with the invention read from the following description of a preferred example embodiment. In the drawings representing the example embodiment merely diagrammatically

FIG. 1 is a side view of a motor vehicle and

FIG. 2 is a cross-section taken along the line 11 in FIG. 1 and

FIG. 3 is a view in perspective of a tubular duct.

### DETAILED DESCRIPTION OF THE INVENTION

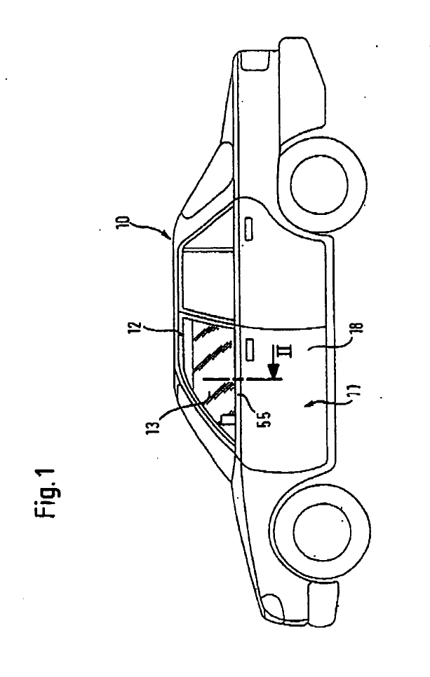

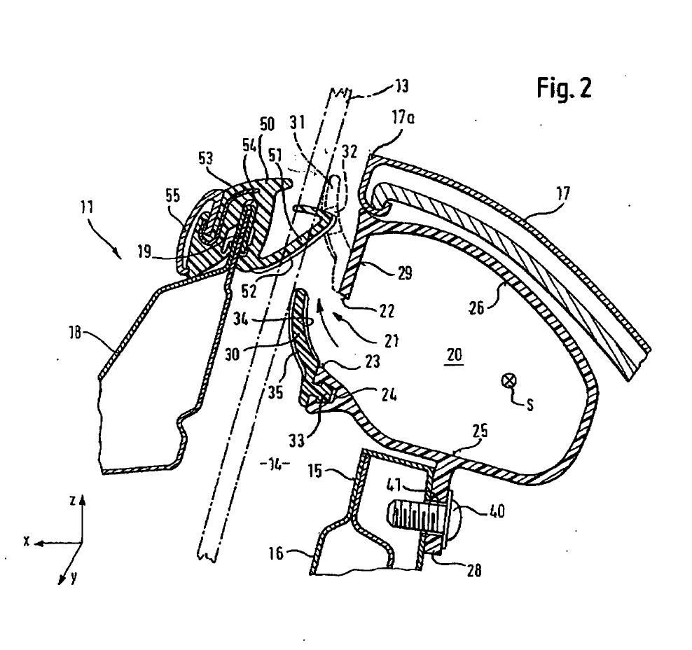

Referring now to FIG. 1 there is illustrated a motor vehicle 10 comprising a door 11 provided with a frame 12. Located powered within the frame 12 is a window pane 13. As evident from FIG. 2 the door 11 comprises for this purpose a cavity 14 to accommodate the window pane 13.

The cavity 14 is sealed by a weatherseal 50 secured to a flange 19 formed by an outer panel 18 of the door 11. The weatherseal 50 comprises in contact with the window pane 13 a sealing lip 51 which is provided with a flaking 52 to reduce friction. In addition, the weatherseal 50 extruded for instance from EPDM comprises a securing portion strengthened by a reinforcement insert 53 and having a recess 54 mounted on the flange 19. Furthermore, secured to the weatherseal 50 is a trim strip 55 made of metal, for instance, to enhance the visual appeal of the weatherseal 50.

As further evident from FIG. 2 the cavity 14 comprises an inner wall 15 strengthened by a carrier 16 serving as collision protection. Secured to the carrier 16 is a tubular duct 20 configured as a separate component and extending between the carrier 16 and an inner trim 17 of the door 11 along the window pane 13. The duct 20 made of a thermoplastic elastomer is provided with as orthogonally downswept flange 28 extending in the fitted condition of the duct 20 roughly in the upright direction z and having holes 41 each for a screw fastener 40 for securing to the carrier 16.

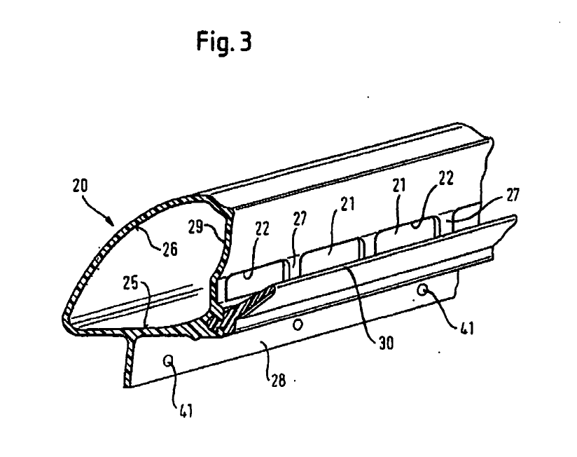

The duct 20 further comprises a plurality of vents 21 located opposite the window pane 13 and each separated from the other by a ridge 27, as evident from FIG. 3. The vents 21 extend roughly parallel to the window pane 13 and are defined in the upright direction z by an upper edge 22 and a lower edge 23. The lower edge 23 is located level with a bottom surface 25 of the duct 20, whereas the upper edge 22 is located in the upright direction z below the top surface 26 of the duct 20. A sidewall 29 extending between the upper edge 22 and the top surface 26 terminates the duct 20 above the vents 21.

In the region of the lower edge 23 the duct 20 is positively connected to a lower sealing lip 30, which, for this purpose, comprises an appendage 33, which engages a recessed groove 24 of the duct 20. The lower sealing lip 30 made of TPE or EPDM is in contact with the window pane 13 in sealing the cavity 14 at the side of the window pane 13 opposite the weatherseal 50. For this purpose the underside of the lower sealing lip 30 is provided with a friction reducing flaking 35, it being just as possible to also provide the upper side of the lower sealing lip 30 with a coating 34 to boost the resistance of the lower sealing lip 30 to wear and tear and heat as regards an air flow jetted from the vents 21.

In addition, depending on the particular application an upper sealing lip 31 contacting the window pane 13 and spaced away from the lower sealing lip 30 in the upright direction z can be secured to a duct 20. As evident from FIG. 2 the upper sealing lip 31 can be arranged in the region of the upper edge 22 and provided with ports 32.

The duct 20 and the lower sealing lip 30 as well as, where necessary, the upper sealing lip 31 form an air vent module primarily serving to deice and demist the window pane 13. For this purpose a heated flow of air is directed through the duct 20. The air flow is jetted from the duct 20 via the vents 21 in a transverse direction x perpendicular to the main direction flow S in flowing over the lower sealing lip 30 to the window pane 13. The lower sealing lip 30 serves to direct the air flow jetted from the vents 21 to the window pane 13 so that the air flow impinges the window pane 13 practically tangentially. This is supported by both the lower sealing lip 30 and the section of the bottom surface 25 flush with the lower sealing lip 30 extending inclined in the transverse direction x as evident from FIG. 2. This near tangential impingement of the air flow ensures fanning the window pane 13 in the upright direction z, this also being assisted by the surface area of the inner trim 17 facing the window pane 13 having a sharp perturbation edge 17a radiused preferably zero.

When the upper sealing lip 31 is secured to the duct 20, the cavity 14 is, for one thing, additionally weathersealed and, for another, the air flow jetting from the vents 21 is additionally directed at the window pane 13. To prevent the air flow backing up between the lower sealing lip 30 and upper sealing lip 31, ports 32 are provided to assist fanning of the window pane 13. Providing the upper sealing lip 31 is optional since the lower sealing lip 30 as a rule is sufficient for directing the air flow as desired.

The air vent module as described above is characterized by a relatively large flow cross-section of the duct 20. The reason for this is the arrangement of the duct 20 in the cavity 14 making sufficient space available between the carrier 16 and the trim 17. The air vent module primarily serves to maintain the window pane 13 free of fog and ice, it being necessary in this case to direct heated air through the duct 20 for instance from a heater of the motor vehicle 10. As an alternative it is just as possible to direct cooled air through the duct 20, for instance, from the air-conditioner of the motor vehicle 10. The cooled air flows along the window pane 13 into the interior of the motor vehicle 10 to create a comfortable atmosphere for the vehicle occupants. Last but not least, in the latter case the lower sealing lip 30 and, where necessary, the upper sealing lip 31 contribute towards a flow of cooled air in the vicinity of the window pane 13 and thus to a convection as is hardly experienced by the occupants of the motor vehicle 10.

What is claimed is:

1. An air vent module for window panes, comprising a tubular duct extending along a window pane and having at least one vent opposite said window pane, said vent extending in an upright direction roughly parallel to said window pane and being limited by an upper edge and a lower edge, and said duct being disposed in a door cavity accommodating said window pane and comprising a lower sealing lip in contact with said window pane, wherein said lower sealing lip for jetting said window pane by an air flow emerging from said vent is arranged in the region of said lower edge.

2. The air vent module as set forth in claim 1, wherein said lower edge is level with a bottom surface of said duct.

3. The air vent module as set forth in claim 1, wherein said upper edge is located in the upright direction below a top surface of said duct.

4. The air vent module as set forth in claim 1, wherein an upper sealing lip is secured to said duct in contact with said window pane and spaced away in said upright direction from said lower sealing lip, said upper sealing lip being preferably arranged in the region of said upper edge.

5. The air vent module as set forth in claim 4, wherein said upper sealing lip is provided with ports.

6. The air vent module as set forth in claim 1, wherein said lower sealing lip and/or said upper sealing lip are positively connected to said duct.

7. The air vent module as set forth in claim 6, wherein said lower sealing lip and/or said upper sealing lip comprise an appendage, which locates in a recessed groove of said duct.

8. The air vent module as set forth in claim 1, wherein said lower sealing lip and/or said upper sealing lip are made of a thermoplastic elastomer or ethylene propylene diene monomer.

9. The air vent module as set forth in claim 1, wherein said upper side of said lower sealing lip and/or said underside of said upper sealing lip are provided with a coating.

10. The air vent module as set forth in claim 1, wherein said duct comprises a flange for securing to an inner wall of said door cavity, preferably to a carrier serving as reinforcement.

11. The air vent module as set forth in claim 10, wherein said flange projects approximately orthogonally from said duct and preferably in said upright direction.

12. The air vent module as set forth in claim 1, further comprising a plurality of vents each separated from the other by a ridge.

13. The air vent module as set forth in claim 1, wherein said duct is made of plastics, preferably of a thermoplastic elastomer.

14. The air vent module as set forth in claim 1, wherein the window panes are automotive window panes.
